(19) United States
(12) Patent Application Publication
(10) Pub. No.: US 2025/0109337 A1
(43) Pub. Date: Apr. 3, 2025

(54) ALKALINE SUSPENDING SYSTEMS CONSTRUCTED FROM HYDROTROPES AND AMINES

(71) Applicant: Stepan Company, Northbrook, IL (US)

(72) Inventors: John Hawkins, Greater Manchester (GB); George Forrest, Greater Manchester (GB); Andrew Marsden, Yorkshire (GB)

(21) Appl. No.: 18/978,130

(22) Filed: Dec. 12, 2024

Related U.S. Application Data
(63) Continuation of application No. PCT/US2023/068665, filed on Jun. 19, 2023.

(51) Int. Cl. C09K 23/00; A01N 25/16; C01B 32/194; C09K 23/02; C09K 23/06; C09K 23/16

(52) U.S. Cl. CPC C09K 23/017; A01N 25/16; C01B 32/194; C09K 23/02; C09K 23/06; C09K 23/16

(57) ABSTRACT

Non-settling aqueous-based pourable alkaline suspensions may be prepared from mixtures of at least one water soluble amphiphile and at least one oil soluble amphiphile, wherein the amphiphiles have from 6 to 11 carbon atoms in the hydrophobic portion of the amphiphile. The water soluble amphiphiles are classed as hydrotropes, and the oil soluble amphiphile component contains at least one amine group.

### RELATED APPLICATIONS

This application claims priority to and is a continuation of co-pending PCT Application No. PCT/US23/68665 having an international filing date of Jun. 19, 2023, which is incorporated herein by reference, and which claims priority to U.S. Provisional Application No. 63/353,791, having a filing date of Jun. 20, 2022, which is also incorporated herein by reference in its entirety.

### FIELD OF THE INVENTION

The present invention relates to alkaline, structured, low foaming amphiphile suspending systems for preparing suspensions of water-insoluble (or sparingly water-soluble) solid particles or liquids. The invention further relates to compositions comprising the suspending systems.

### BACKGROUND OF THE INVENTION

A recent patent application, U.S. provisional application No. 63/308,452, claims novel structured low foaming compositions that are extremely cost effective and capable of suspending immiscible solid or liquid particles without sedimentation using blends of short chain (i.e. from 7 to 11 carbon atoms) amphiphiles in water. The system comprises a mixture of at least one water soluble amphiphile and at least one water insoluble amphiphile, wherein the at least one water soluble amphiphile is a hydrotrope. The hydrotrope is a high HLB hydrotrope having an HLB value of 10 or more and the at least one water insoluble amphiphile is a low HLB amphiphile having an HLB value of less than 10 and containing at least one hydroxyl group.

Without wishing to be bound by theory, it was believed that the hydroxyl groups provided hydrogen bonding, which ‘cemented’ the amphiphiles together into regular nano-sized droplets of lamellar liquid crystal. The regular sized nano droplets have a positively charged surface (although they are overall electrically neutral) and it is believed that the unequal charge distribution across the droplets causes the droplets to constantly repel each other, resulting in a 3 D structure having a yield point that can suspend solids, liquids, or gases. The systems have a high optical clarity and have a significant yield point, which is evidenced by the fact that they are capable of suspending air bubbles.

It has now been found that structured suspending systems can be constructed from mixtures of short chain (i.e. C7-C11 carbon atoms) hydrotropes and amine-containing amphiphiles. Surprisingly, such suspending systems are shear-thickening, which is opposite the shear-thinning behaviour of the suspending systems formed from hydroxyl-containing water insoluble amphiphiles and hydrotropes.

### SUMMARY OF THE INVENTION

According to a first aspect of the invention, there is provided an alkaline structured aqueous system having a yield point and capable of suspending particles of solid, liquid or gas, wherein the system comprises a mixture of at least one water soluble amphiphile and at least one water insoluble amphiphile. The at least one water soluble amphiphile is a hydrotrope, and the at least one water-insoluble amphiphile contains at least one amine group. In a further aspect, the hydrotrope has at least one polar head group and a lipophilic portion having less than 12 carbon atoms per polar head group. It has been a most unexpected and surprising discovery to find that low foaming, shear-thickening structured lamellar suspending systems comprising a high proportion of hydrotrope can be successfully formulated. The systems may have a high optical clarity and have a significant yield point, which is evidenced by the fact that they are capable of suspending air bubbles.

The structured suspending systems can be used to suspend water-insoluble materials for use in industrial applications, such as graphene or diamond powder, where high-foaming surfactants are not appropriate. Accordingly, a further aspect of the invention is a composition comprising an alkaline structured system comprising (a) from 2% to 50% by weight based on the weight of the structured aqueous system of a mixture of at least one water soluble amphiphile and at least one water insoluble amphiphile, wherein the at least one water soluble amphiphile is a hydrotrope comprising at least one polar head group and a lipophilic tail group with from 6 to 11 carbon atoms per polar head group, and the at least one water-insoluble amphiphile contains at least one amine group; (b) at least one of solid, liquid, or gaseous particles suspended in the alkaline structured system; and (c) water to total 100% of the composition. In some embodiments, the solid particles comprise about 0.5% to about 25% by weight of the composition. In some embodiments, the solid particles are graphene particles.

Another aspect of the invention is a method of preparing a stable graphene dispersion, comprising (a) forming an alkaline structured aqueous system comprising water and from 2% to 50% by weight based on the weight of the structured aqueous system of a mixture of at least one water soluble amphiphile and at least one water insoluble amphiphile, wherein the at least one water soluble amphiphile is a hydrotrope comprising at least one polar head group and a lipophilic tail group with from 6 to 11 carbon atoms per polar head group, and the at least one water-insoluble amphiphile contains at least one amine group; and (b) suspending the graphene particles in the structured aqueous system to form the stable graphene dispersion.

### BRIEF DESCRIPTION OF THE DRAWINGS

FIG. 1 shows the chemical structures of exemplary Low HLB amphiphiles that can be used in the present invention.

FIG. 2 shows the chemical structures of exemplary High HLB hydrotropes that can be used in the present invention.

### DETAILED DESCRIPTION

The present invention relates to an alkaline suspending system based on a lamellar mesophase that is constructed from amphiphilic molecules. It has a high degree of optical clarity, is low foaming and may be extremely low in electrolytes. A system having a high degree of optical clarity typically has a percent transmittance of light of greater than about 50 using a 1 centimeter cuvette at a wavelength of 570 nanometers wherein the composition is measured in the absence of dyes and opacifiers at 25° C. “Low foaming” means any foam that is generated during processing to form the suspending system is transient and collapses within a few seconds. A system that is extremely low in electrolytes is one that has less than 2%, preferably less than 1% by weight electrolytes. For example, the structured suspending system may be free of electrolytes. The alkaline suspending systems of the present technology are also shear-thickening, exhibiting an increase in viscosity when shaken or sheared over time. Once shearing is stopped, the alkaline suspending systems return to their initial viscosity over time, usually within 24 hours. The suspending systems have wide-ranging applications as a suspending medium for payloads such as pesticides, pigments, graphene, oils etc.

The amphiphilic molecules used in preparing the suspending system comprise at least one water insoluble amphiphile containing an amino group, and at least one water soluble amphiphile that is a hydrotrope. A hydrotrope is a molecule that has a hydrophilic or polar head group and a hydrophobic (lipophilic) tail group, but the tail group is generally too small to cause spontaneous self-association or aggregation in aqueous solutions. The particular combinations of water-insoluble amine-containing amphiphile and hydrotrope can form shear-thickening structured systems that have a yield point and are capable of suspending solid particles, liquid droplets, and gas bubbles.

The amphiphiles for use in preparing the structured suspending system should comprise at least one amphiphile with a hydrophilic-lipophilic balance (HLB) that is low, for example less than 10, and at least one amphiphile with a high HLB, for example 10 or greater. The overall HLB of the mixture should be in a range in which liquid crystals form, which may be around 11 to 13, preferably about 12 HLB units.

The low HLB amphiphile comprises a lipophilic tail group comprising less than 12 carbon atoms, and at least one amine group. In some embodiments, the low HLB amphiphile may comprise at least one lipophilic tail comprising from 4 to 11 carbon atoms, alternatively 5 to 11 carbon atoms, alternatively 6 to 11 carbon atoms, alternatively 7 to 11 carbon atoms. The lipophilic tail group may be linear or branched.

In some embodiments, the low HLB amphiphile may comprise at least one linear tail having a carbon chain comprising 4, 5, 6, 7, 8, 9, or 10 carbon atoms. In other embodiments, the low HLB amphiphile can have a branched or cyclic (including aromatic) tail having 6, 7, 8, 9, or 10 carbon atoms. Without wishing to be bound by theory, it is believed that the amine group(s) of the low HLB amphiphile interchange protons with the headgroup(s) of the hydrotrope. This is believed to be the driving force for nano droplet formation and the ‘cement’ that holds the droplets together. Examples of suitable water insoluble amphiphiles for forming the suspending system include, but are not limited to, octylamine, para ethyl aniline, para toluidine, and 4-isopropyl aniline.

It is also possible to produce mixed hydrogen bonded (amino plus hydroxyl) systems. These mixed systems may in fact be preferred for some applications, since pure amino hydrogen bonding has been found to impart shear thickening behaviour in the structured systems. This is believed to be due to the amino group giving droplet-droplet hydrogen bonding, and it is the associated clusters of droplets that cause thickening with applied shear.

The high HLB amphiphile or hydrotrope comprises at least one polar head group and at least one lipophilic tail. The lipophilic tail can be aliphatic or aromatic. The hydrotrope may have a lipophilic tail comprising at least 5, alternatively about 6, about 7, about 8, about 9, about 10 carbon atoms, or about 11 carbons. In some embodiments, the lipophilic tail is a linear lipophilic tail. In embodiments comprising a linear lipophilic tail, the carbon chain may comprise 5, alternatively about 6, about 7, about 8, about 9, about 10 or about 11 carbon atoms. In some embodiments, the lipophilic tail is a cyclic or branched tail. For 6 carbon cyclic (including aromatic) tails, the tail should have at least one pendant methyl group. Alkyl benzene sulphonates containing 6 or more carbon atoms in the alkyl portion are not considered hydrotropes as defined herein. The polar group can comprise a sulfate, sulphonate, carboxylate, or phosphate group. The counterion for the polar head group can be sodium, potassium, lithium, monoethanolamine, diethanolamine, or triethanolamine.

In some embodiments, the high HLB amphiphile may have dual or twin polar head groups. For example, it is believed that sulphonated oleic acid may function as a high HLB component in the structured aqueous system. Without being bound by theory, this may be due to those molecules in the mixture that have been sulphonated at the double bond to produce a short-tailed, twin-headed hydrotrope. These molecules are believed to bunch and fold in the vesicle so that around 10 carbon atoms are incorporated in the lipophilic portion of the bi-layer.

Phosphoric acid di-(C4-C18)-alkyl esters may also function as a hydrotrope in the structured aqueous systems.

For hydrotropes having single and cyclic tails, the total number of carbon atoms may be between 7 and 11. It is believed that a tail comprising 7-11 carbon atoms produces sufficient lipophilic nature to allow the tails to associate into liquid crystal bi-layers. For hydrotropes having twin-headed hydrotropes, the number of carbon atoms may be 7-11 carbon atoms per polar head group. Examples of hydrotropes that can be used in the present invention are triethanolamine octanoate, ethanolamine octanoate, sodium octyl sulphate, sodium cumene sulphonate, sodium xylene sulphonate, sodium toluene sulphonate, sulphonated oleic acid, ammonium octyl sulphate, triethanolamine octyl sulphate, and octylamine hydrochloride.

Experiments indicate that for linear tails, a minimum chain length of around 7-8 carbon atoms is preferred in order to form liquid crystals. Amphiphiles with a chain length shorter than this may be too soluble. The preferred short chain lengths of the lipophilic tails of the amphiphiles, i.e. around 7 to 10 carbon atoms, are believed to form narrow bi-layers that are extremely flexible, and this flexibility allows them to pack into micro-vesicles which contain only a small number (e.g. 5) of concentric shells. It is believed that these micro-vesicles are nano droplets of lamellar phase that have a positively charged surface, although they are overall electrically neutral. Without being bound by theory, it is believed that the unequal charge distribution across the droplets causes the droplets to constantly repel each other, resulting in a 3 D structure having a yield point that can suspend solids, liquids, or gases.

Linear amphiphiles with longer chains, i.e. 12 carbon atoms and above, may give thicker bi-layers which are more rigid and tend to pack into multilamellar macro vesicles with several dozen concentric shells. The macrovesicles are of a size that they reflect rather than transmit light with the consequence that these particular systems are opaque.

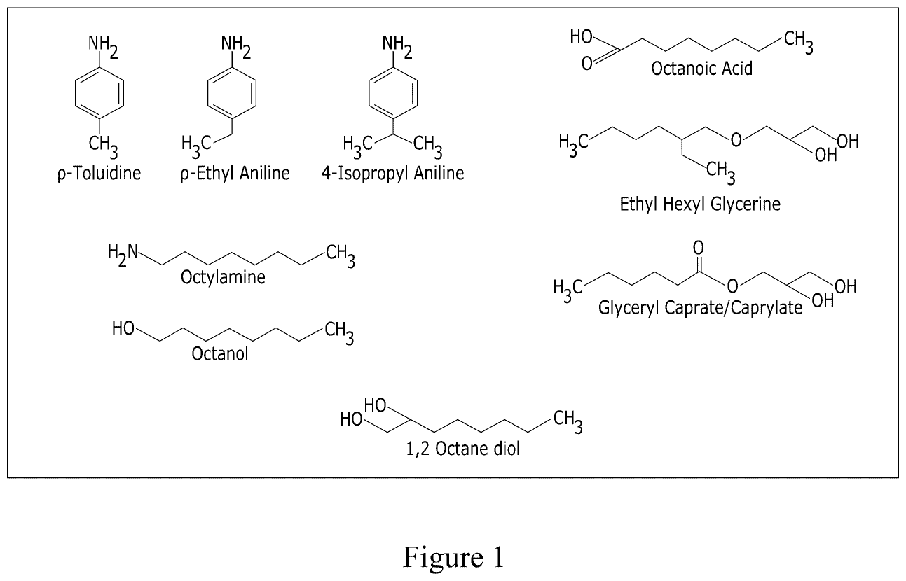

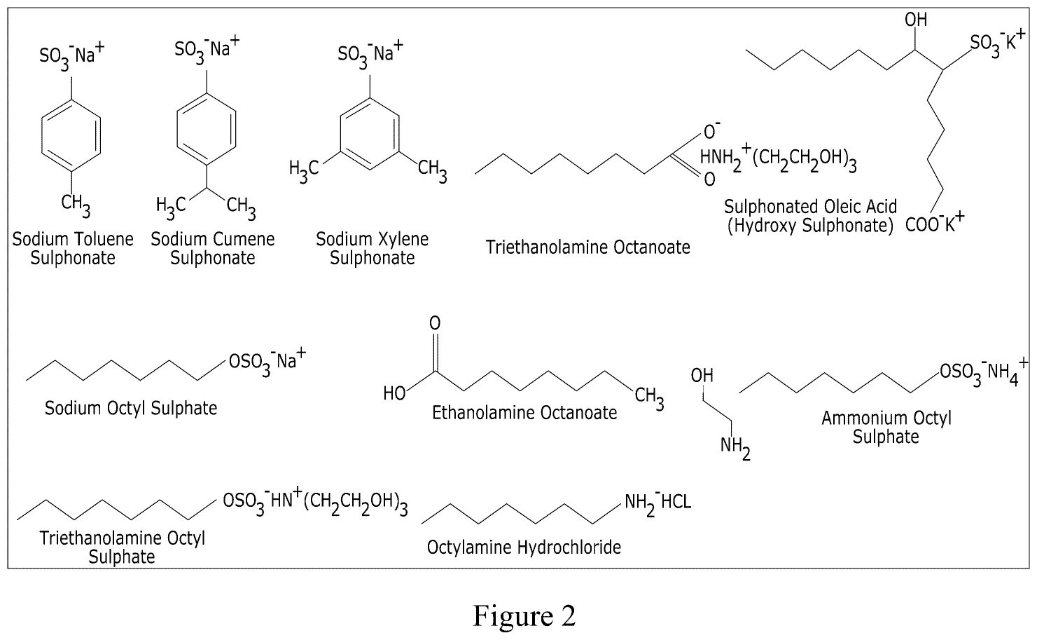

FIG. 1 provides examples of low HLB (water insoluble) amphiphiles of the invention that have been found to be effective for forming the structured alkaline suspending systems. FIG. 2 provides examples of high HLB (water soluble) amphiphiles of the invention that have been found to be effective for forming the structured alkaline systems. Any combination of the low HLB amphiphiles in FIG. 1 may be blended together with any combination of the high HLB amphiphiles (hydrotropes) in FIG. 2 to produce alkaline structured aqueous systems, provided the combination of low HLB amphiphiles includes at least one amphiphile containing an amine group. The alkaline structured aqueous systems formed from the combinations of low HLB amphiphiles and high HLB amphiphiles have a high degree of clarity and are capable of suspending solids. However, the amphiphiles shown in FIGS. 1 and 2 are not intended to be an exhaustive listing of examples of the invention.

The at least one water soluble amphipile and the at least one water insoluble amphiphile are mixed together in water to give the structured aqueous system. The active components of the suspending system (i.e. the hydrotrope and the at least one water insoluble amphiphile) may be present in a total amount of about 2 to about 50% w/w, about 4 to about 45% w/w, about 6 to about 40% w/w, about 8 to about 35% w/w, about 10 to about 30% w/w, or about 15 to about 25% w/w, based on the total weight of the structured aqueous system.

The hydrotrope and the at least one water insoluble amphiphile may be present in a total amount of at least about 2% w/w, about 4% w/w, about 6% w/w, about 8% w/w, about 10% w/w, about 12% w/w, about 14% w/w, about 16% w/w, about 18% w/w, about 20% w/w, about 22% w/w, about 24% w/w, about 26% w/w, about 28% w/w, about 30% w/w, about 35% w/w, about 40% w/w, about 45% w/w, or at least about 50% w/w, based on total weight of the structured aqueous system.

In some embodiments, the concentration of the amphiphiles may need to be 10% by weight or more in order “pack” the available volume and provide a yield point. However, adding a component to the structured aqueous system that can increase the repulsion of the nano droplets may be able to provide a yield point at an actives concentration of less than 10%. Components that may be able to increase the repulsion between nano droplets include morpholine soaps, C8/C10 alkyl amine oxides, 1,4-thiazine, thiomorpholine, and thiomorpholine 1,1 dioxide.

The ratio of hydrotrope to water insoluble amphiphile is determined at least in part, by the particular hydrotrope and water insoluble amphiphile forming the structured system. Suitable suspending systems comprising the high and low HLB amphiphiles, and the optimum ratio of the particular constituents, can be determined by experiment. Various ratios of the hydrotrope and water insoluble amphiphile are preblended together, then diluted with water to a total active concentration of about 15% by weight and mixed (manual low shear mixing). Those compositions that thicken on mixing and remain substantially transparent then have air shaken into them. Isotropic compositions that suspend air bubbles are identified, and then assessed as ‘strong’ or ‘weak’ (high or low yield point) depending on whether the systems suspend large or small air bubbles. Over a range of samples prepared with differing ratios of high to low HLB amphiphiles, it is usual for several samples to show suspending properties. The mid-range samples of a range tend to exhibit the highest yield points, i.e. suspend the largest bubbles, the centre of the mid-range is therefore identified as the optimum ratio for micro vesicle formation. In general, suitable weight ratios of water insoluble amphiphile to hydrotrope may be in the range of 1:1 to about 4:1.

The structured aqueous system is prepared by low-shear mixing of each of the constituent components together at room temperature, or temperature above room temperature, for example about 27, about 28, about 29, about 30, about 32, about 34, or about 35° C. Mixing is applied until the blend thickens and attains a yield point, which is when the blend becomes capable of suspending insoluble (solid, liquid or gas) particles. The amphiphiles are usually (but not essentially) pre-blended together before dispersing in the water. This has the advantage of preventing any unwanted emulsification from taking place. Pre-blending the amphiphiles also has the additional benefit of preparing marketable concentrates for sale to customers who prefer to manufacture the finished structured liquid formulation ‘in house’. The high active concentrates are still pourable and disperse readily with low shear mixing at room temperature to form the structured aqueous systems. Although shear-thickening, the resulting structured aqueous systems have a low enough viscosity that they are flowable, and achieve good suspending ability without the addition of electrolytes, i.e. they can be electrolyte-free. In some embodiments, the structured aqueous systems are transparent or slightly hazy.

The structured aqueous system may be stable at temperatures ranging from 0 to 60° C., with some systems being stable even at lower or higher temperatures. The structured aqueous systems are low-foaming systems that can be used to suspend a variety of solid, liquid, or gas particles, and are particularly useful for applications where foaming is not desired, or where surfactant systems cannot be used due to interactions with the dispersant material. Since the structured systems are alkaline, they could be beneficial for suspending acidic material, or could be used in applications where an acidic system would not be appropriate or where the pH needs to be controlled. The shear-thickening behaviour of the structured alkaline systems may make such systems useful for preventing settling out of suspended solids, such as during transport. Material suspended in shear-thinning systems may have a tendency to settle out during transport due to movement. The structured alkaline systems of the present technology may be better able to maintain the material in suspension due to the shear-thickening behaviour of the alkaline structured system.

Particulate solids that can be suspended in the present structured aqueous systems include, but are not limited to, graphene, diamond powder, pesticides and herbicides, and pigments. The amount of particulate solids that can be suspended in the present structured aqueous systems can range from about 0.5% to about 25% by weight of the structured aqueous system. The structured aqueous systems may be used in many different applications, such as the preparation of graphene dispersions, diamond suspensions (lapping fluids), oil-free lubricants, cutting fluids, agricultural compositions such as pesticide, herbicide, and/or fertilizer suspensions, pigment suspensions, suspensions of adhesives, media for 3D printing, and ink suspensions.

In some embodiments, the alkaline structured aqueous system can be used to suspend graphene particles. One aspect of the present technology is therefore a method for preparing a stable graphene dispersion. The graphene dispersion can be prepared by forming an alkaline structured aqueous system comprising water and from 2% to 50% by weight based on the weight of the structured aqueous system of a mixture of at least one water soluble amphiphile and at least one water insoluble amphiphile containing at least one amine group, wherein the at least one water soluble amphiphile is a hydrotrope comprising at least one polar head group and a lipophilic tail group with from 6 to 11 carbon atoms per polar head group; and suspending the graphene particles in the structured aqueous system to form the stable graphene dispersion. In some embodiments, the graphene particles can be mixed with the hydrotrope and water to form a homogenous mixture, and then the low HLB, water-insoluble amphiphile can be added to the mixture to form the structured aqueous system with the graphene particles stably dispersed within the structured aqueous system. Alternatively, the low HLB, water-insoluble amphiphile and the hydrotrope can be mixed together to form the alkaline structured aqueous system, and the graphene particles can be mixed with the structured aqueous system to form the stable graphene dispersion. In some embodiments, the low HLB amphiphile and the hydrotrope can be pre-blended to form a concentrate, which is then diluted to form the structured aqueous system. The graphene particles could be mixed with the concentrate prior to dilution.

### EXAMPLES

The following examples describe some of the preferred embodiments of the present technology without limiting the technology thereto. Other embodiments include, but are not limited to, those described in the above written description, including additional or alternative components, alternative concentrations, and additional or alternative properties and uses.

### Example 1

A 3:1 w/w blend of octylamine: octylamine hydrochloride was prepared at 11.0% by weight total actives by adding octylamine to hydrochloric acid solution at room temperature and stirring the mixture gently by hand. The resultant sample had a slight haze and a viscosity of ca. 2000 cp at room temperature. It had a strong yield point (as evidenced by its suspension of large air bubbles) and was found to thicken when stirred. On cessation of stirring, the viscosity was found to reduce to the original value.

### Example 2

A 1:1.6 w/w blend of sulphonated oleic acid: octylamine was prepared at 11.6% by weight total actives by adding octylamine to sulphonated oleic acid solution at room temperature and stirring the mixture gently by hand. The resultant sample had a slight haze and a viscosity of ca. 1500 cp at room temperature. It had a strong yield point (as evidenced by its suspension of large air bubbles) and was found to thicken when stirred. On cessation of stirring, the viscosity was found to reduce to the original value.

### Example 3

A 1:1 w/w blend of sodium cumene sulphonate: octylamine was prepared at 20.0% by weight actives by adding octylamine to sodium cumene sulphonate solution at room temperature and stirring the mixture gently by hand. The resultant sample was hazy and had a viscosity of ca. 1500 cp at room temperature. It had a strong yield point (as evidenced by its suspension of large air bubbles) and was found to thicken when stirred. On cessation of stirring, the viscosity was found to reduce to the original value.

### Example 4

A structured system for suspending graphene is prepared from a 3:1 w/w blend of octylamine: octylamine hydrochloride at 4% by weight total actives. The system is able to suspend 20% w/w 100% graphene powder (PUREGRAPH 50 from First Graphene), even with a total actives amount of only 4%.

The present technology is now described in such full, clear and concise terms as to enable a person skilled in the art to which it pertains, to practice the same. It is to be understood that the foregoing describes preferred embodiments of the present technology and that modifications may be made therein without departing from the spirit or scope of the present technology as set forth in the appended claims. Further, the examples are provided to not be exhaustive but illustrative of several embodiments that fall within the scope of the claims.

1. An alkaline structured aqueous system having a yield point and capable of suspending particles of solid, liquid or gas, the structured aqueous system comprising:
(a) from 2% to 50% by weight based on the weight of the structured aqueous system of a mixture of at least one water soluble amphiphile and at least one water insoluble amphiphile containing at least one amine group, wherein the at least one water soluble amphiphile is a hydrotrope comprising at least one polar head group and a lipophilic tail group with from 6 to 11 carbon atoms per polar head group, and (b) water to total 100% of the structured aqueous system.

2. The structured aqueous system of claim 1, wherein the at least one water soluble amphiphile and the at least one water insoluble amphiphile are present in a total amount of between 10% and 30% by weight of the structured aqueous system.

3. The structured aqueous system of claim 1, wherein the water insoluble amphiphile has a hydrophobic tail portion containing from 6 to 11 carbon atoms.

4. The structured aqueous system of claim 1, wherein the hydrotrope is selected from the group consisting of sodium toluene sulphonate, sodium xylene sulphonate, sodium cumene sulphonate, sodium octyl sulphate, triethanolamine octanoate, ethanolamine octanoate, sulphonated oleic acid, octyl amine hydrochloride, ammonium octyl sulphate, triethanolamine octyl sulphate, and phosphoric acid di-(C4-C18)-alkyl esters.

5. The structured aqueous system of claim 1, wherein the water insoluble amphiphile is selected from the group consisting of octylamine, para ethyl aniline, isopropyl aniline, and para toluidine.

6. The structured aqueous system of claim 1, wherein the weight ratio of water insoluble amphiphile to hydrotrope is in the range of 1:1 to 4:1.

7. The structured aqueous system of claim 1, wherein the structured aqueous system has an overall Hydrophilic Lipophilic Balance (HLB) value in the range of about 11 to about 13.

8. The structured aqueous system of claim 1, wherein the structured aqueous system further comprises solid particles, liquid droplets, or gas bubbles stably suspended within the structured aqueous system.

9. The structured aqueous system of claim 8, wherein the solid particles comprise graphene.

10. The structured aqueous system of claim 8, wherein the solid particles comprise up to 25% by weight of the structured aqueous system.

11. A composition comprising:
(a) a structured aqueous system comprising from 2% to 50% by weight based on the weight of the structured aqueous system of a mixture of at least one water soluble amphiphile and at least one water insoluble amphiphile containing at least one amine group, wherein the at least one water soluble amphiphile is a hydrotrope comprising at least one polar head group and a lipophilic tail group with from 6 to 11 carbon atoms per polar head group;
(b) at least one of solid, liquid, or gaseous particles suspended in the structured aqueous system; and
(c) water to total 100% of the composition.

12. The composition of claim 11, wherein the at least one water soluble amphiphile and the at least one water insoluble amphiphile are present in a total amount of between 10 and 30% by weight of the structured aqueous system.

13. The composition of claim 11, wherein the water insoluble amphiphile has a hydrophobic tail portion containing between 6 and 11 carbon atoms.

14. The composition of claim 11, wherein the hydrotrope is selected from the group consisting of sodium toluene sulphonate, sodium xylene sulphonate, sodium cumene sulphonate, sodium octyl sulphate, triethanolamine octanoate, ethanolamine octanoate, sulphonated oleic acid, octyl amine hydrochloride, ammonium octyl sulphate, triethanolamine octyl sulphate, and phosphoric acid di-(C4-C18)-alkyl esters.

15. The composition of claim 11, wherein the water insoluble amphiphile is selected from the group consisting of octylamine, para ethyl aniline, isopropyl aniline, and para toluidine.

16. The composition of claim 11, wherein the solid particles suspended in the structured aqueous system comprise from 0.5% to 25% by weight of the structured aqueous system.

17. The composition of claim 16, wherein the solid particles suspended in the structured aqueous system comprise graphene particles.

18. A method of preparing a stable graphene dispersion comprising:
(a) forming an alkaline structured aqueous system comprising water and from 2% to 50% by weight based on the weight of the structured aqueous system of a mixture of at least one water soluble amphiphile and at least one water insoluble amphiphile containing at least one amine group, wherein the at least one water soluble amphiphile is a hydrotrope comprising at least one polar head group and a lipophilic tail group with from 6 to 11 carbon atoms per polar head group; and
(b) suspending graphene particles in the alkaline structured aqueous system to form the stable graphene dispersion.

19. The method of claim 18, wherein the graphene dispersion comprises up to 25% by weight of graphene particles.
